(19) United States
(12) Patent Application Publication
(10) Pub. No.: US 2024/0375294 A1
(43) Pub. Date: Nov. 14, 2024

(54) TOOL FOR HOLDING AN OBJECT

(71) Applicant: THE HAND SAFETY TOOL COMPANY, LLC, MISSOURI CITY, TX (US)

(72) Inventor: CHRISTOPHER RYAN LEE, MISSOURI CITY, TX (US)

(21) Appl. No.: 18/655,447

(22) Filed: May 6, 2024

Related U.S. Application Data
(60) Provisional application No. 63/464,876, filed on May 8, 2023.

(51) Int. Cl. B25J 15/00; B25J 1/00

(52) U.S. Cl. CPC B25J 15/0038; B25J 1/00

(57) ABSTRACT

An apparatus includes an elongate shaft having a first passageway extending therethrough, a housing secured to the shaft, a cam buckle, and a flexible strap extending through the shaft and housing. The housing includes a buckle chamber, a chamber window, and a second passageway extending through the buckle chamber into communication with the first passageway. The cam buckle is secured within the buckle chamber, wherein the cam buckle includes a frame and a cam member pivotably secured to the frame. The cam member includes a gripping surface and a release button accessible through the chamber window. The strap includes a first end secured to a rigid member within the shaft or housing and an accessible second end. The strap forms a loop adjacent a distal end of the shaft for receiving an object, wherein pulling the strap causes the loop to tighten around the object.

### BACKGROUND

The present disclosure relates to a tool for safely holding an object.

### BACKGROUND OF THE RELATED ART

Serious hand injuries can occur when a person's hand is placed in a dangerous location or position. Often, the person will use their hand to hold an object in a desired position during some necessary process that poses danger of injury. For example, it is generally necessary to hold a spike in a desired position relative to a substrate before striking the spike with a hammer or hold a wrench in engagement with a bolt head before striking the wrench with a hammer. If the person's hand is directly holding the spike or the wrench, the hammer may accidentally strike the person's hand.

### BRIEF SUMMARY

Some embodiments provide an apparatus comprising an elongate shaft having a proximal end, a distal end, and a first passageway extending through the elongate shaft from the proximal end to the distal end. The apparatus further comprises a housing secured to the proximal end of the elongate shaft, wherein the housing includes a buckle chamber, a chamber window, and a second passageway extending from a proximal end of the housing through the buckle chamber into communication with the first passageway. The apparatus also comprises a cam buckle secured in a fixed position within the buckle chamber, wherein the cam buckle includes a rigid frame and a cam member pivotably secured to the rigid frame, wherein the rigid frame includes first and second side arms connected by first and second crossbars, and wherein the cam member includes a gripping surface facing the second crossbar and a release button that is accessible through the chamber window. Still further, the apparatus comprises a flexible strap having a first end that is secured to a rigid member within the elongate shaft or housing and a second end that is accessible beyond the proximal end of the housing. The flexible strap extends in a distal direction from the rigid member out the distal end of the elongate shaft, then further extends in a proximal direction from the distal end of the elongate shaft to the proximal end of the elongate shaft, through the second passageway of the housing, and beyond the proximal end of the housing, wherein the flexible strap is disposed between the gripping surface of the cam member and the second crossbar. The flexible strap forms a loop extending from the distal end of the elongate shaft for receiving an object within the loop, wherein pulling the second end of the flexible strap in a proximal direction causes the loop to tighten around the object.

### BRIEF DESCRIPTION OF THE SEVERAL VIEWS OF THE DRAWINGS

FIG. 1 is a perspective view of a tool for holding an object.

FIGS. 2A-B are side views of the tool in a released condition and a holding condition, respectively.

FIGS. 3A-B include a cross-sectional view of the tool taken through a horizontal plane and a cross-sectional view of the tool taken through a vertical plane, respectively.

FIGS. 4A-B are cross-sectional side views of a releasable cam buckle secured within a handle of the tool with the cam buckle in a holding condition and a release condition, respectively.

FIGS. 5A-C include a perspective view, a top view, and a cross-sectional side view of the releasable cam buckle.

FIGS. 6A-B are assembly views of a housing assembly having two housing halves that are securable around the cam buckle, strap and proximal end of the elongate shaft.

### DETAILED DESCRIPTION

Some embodiments provide an apparatus comprising an elongate shaft having a proximal end, a distal end, and a first passageway extending through the elongate shaft from the proximal end to the distal end. The apparatus further comprises a housing secured to the proximal end of the elongate shaft, wherein the housing includes a buckle chamber, a chamber window, and a second passageway extending from a proximal end of the housing through the buckle chamber into communication with the first passageway. The apparatus also comprises a cam buckle secured in a fixed position within the buckle chamber, wherein the cam buckle includes a rigid frame and a cam member pivotably secured to the rigid frame, wherein the rigid frame includes first and second side arms connected by first and second crossbars, and wherein the cam member includes a gripping surface facing the second crossbar and a release button that is accessible through the chamber window. Still further, the apparatus comprises a flexible strap having a first end that is secured to a rigid member within the elongate shaft or housing and a second end that is accessible beyond the proximal end of the housing. The flexible strap extends in a distal direction from the rigid member out the distal end of the elongate shaft, then further extends in a proximal direction from the distal end of the elongate shaft to the proximal end of the elongate shaft, through the second passageway of the housing, and beyond the proximal end of the housing, wherein the flexible strap is disposed between the gripping surface of the cam member and the second crossbar. The flexible strap forms a loop extending from the distal end of the elongate shaft for receiving an object within the loop, wherein pulling the second end of the flexible strap in a proximal direction causes the loop to tighten around the object.

In some embodiments, the elongate shaft may be a linear section of a hollow tube, wherein the hollow tube has a central axis. The hollow tube may, without limitation, have a rectangular or circular profile. The elongate shaft may be made from various materials, such as metal or a rigid polymeric material, such as ultra-high molecular weight polyethylene or similar polymer. Furthermore, the elongate shaft may be made with composite materials, such as fiberglass or carbon-reinforced plastics. The elongate shaft is preferably strong yet lightweight. The length of the elongate shaft may vary widely to be suitable for a particular application or object to be securely held, but a preferred length may be between 1 and 3 feet.

In some embodiments, the housing may be made with the same material as the elongate shaft but may also be made with a different material. The housing may be secured to the elongate shaft in any manner to make a firm connection, such as using one or more fasteners secured through one or more walls of the housing and the elongate shaft. Non-limiting examples of a suitable fastener may include a bolt and nut or a binding post assembly. A binding post assembly includes both an internally threaded binding barrel and a binding screw.

In some embodiments, the housing may be formed by a first housing portion and a second housing portion that are secured together with one or more fasteners. Optionally, the one or more fasteners used to secure the first housing portion to the second housing portion may include the one of more fasteners that secure the housing to the elongate shaft. Each housing portion is preferably a rigid body including a portion of the buckle chamber, a portion of the chamber window, and a portion of the second passageway. Each housing portion may form about half of the housing and may be referred to as a housing half. For example, the two housing half elements may be substantially symmetrical about a central plane.

In some embodiments, the housing may be shaped to include a handhold region immediately adjacent to the chamber window. Accordingly, the diameter and length of the handhold region may be suitable for gripping in a person's hand. Optionally, adjacent regions of the housing may have a greater diameter to facilitate a secure grip and prevent the person's hand from slipping along the housing. In a preferred configuration, a person may grip the handhold region with one hand and operate the release button with the thumb of the same hand without releasing the grip.

A cam buckle is a device or mechanism that is used in combination with a flexible strap to secure the flexible strap with an adjustable length. The cam buckle includes a cam member, such as a spring-biased cam member, with a gripping surface that pushes down on a portion of the flexible strap that is passed between the gripping surface and another surface, such as a crossbar of the cam buckle, to prevent the flexible strap from slipping back through the cam buckle. The gripping surface of the cam member and/or the other surface may be serrated or knurled to provide a better grip on the flexible strap. The portion of the flexible strap that is secured by the cam member may be adjusted by pulling the flexible strap through the fastener. For example, if the flexible strap has been positioned around an object, the end of the flexible strap that passes between the gripping surface and the other surface may be pulled to reduce the effective length of the flexible strap until the flexible strap engages the object and may be pulled further or with a greater force to produce tension in the flexible strap. The cam member is configured so that the tension on the flexible strap that has been pulled through the cam member will cause the gripping surface to have an even tighter grip on the flexible strap such that the flexible strap may be passively retained by the cam member. In order for the flexible strap to be pulled back through the cam member, a person must press (i.e., apply a manual force against) a release button or cam lever to draw the gripping surface out of engagement with the flexible strap.

In some embodiments, the cam buckle may have a rigid frame and the buckle chamber may have a shape that is complementary to a shape of the rigid frame to prevent movement of the rigid frame relative to the buckle chamber. In one option, the buckle chamber may have a distal end that engages a distal end of the cam buckle to prevent distal movement of the cam buckle. In another option, the buckle chamber may have a proximal end that engages a proximal end of the cam buckle to prevent proximal movement of the cam buckle.

In some embodiments, the cam buckle further includes a spring element that biases the gripping surface of the cam member toward the second crossbar, wherein a force pulling on the flexible strap in a distal direction through the cam buckle may cause the gripping surface of the cam member to be further biased against the flexible strap toward the second crossbar. Furthermore, a force pulling on the flexible strap in a proximal direction though the cam buckle may cause the flexible strap to slide between the gripping surface and the second crossbar. Optionally, the first end of the flexible strap may be secured to the first crossbar of the cam buckle.

In some embodiments, the flexible strap may be a woven material known as webbing. Webbing may be a strong fabric that is woven as a flat strip. The flexible strap may be made with a wide variety of fibers including hemp, cotton or linen, but is preferably made with synthetic fibers such as nylon, polypropylene, polyester, ultra-high molecular weight polyethylene, and poly(azanediyl-1,4-phenylencazanediylterephthaloyl). Optionally, the flexible strap may have a width between 0.5 and 2 inches, a thickness between 1 and 3 millimeters, and a length of several fect. However, the dimensions of the strap may vary with the dimensions of the apparatus and the range of dimensions of the objects to be held with the apparatus. In some embodiments, a first portion or area of the flexible strap may be sewn to a second portion or area of the strap, such as to form a permanent loop or to form a stop element having a greater effective thickness than a single layer of the flexible strap. For example, the first end of the flexible strap may be secured to the first crossbar of the cam buckle by looping the first end around the first crossbar and sewing it back to an adjacent portion of the flexible strap. Similarly, the second end of the flexible strap may be formed into a loop that can be used as a hand grip by sewing the second end back to the flexible strap while leaving a loop of a size that can be easily grasped and pulled. Note that the foregoing loops have a fixed dimension since the strap is fastened back to itself. However, the loop extending from the distal end of the elongate shaft for receiving an object has a variable dimension (i.e., diameter, circumference) as described herein.

In some embodiments, a first stop element may be secured to the flexible strap, wherein the first stop element has a dimension that prevents the first stop element from moving through the second passageway of the housing and limits a quantity of the flexible strap that can extend beyond the proximal end of the housing. Optionally, the first stop element may be a short segment of the same flexible strap material sewn face-to-face with the flexible strap. Separately, the second end of the flexible strap may form a loop for pulling the flexible strap in the proximal direction, wherein the loop forms a second stop element having a dimension that prevents the second stop element from moving through the second passageway of the housing.

Some embodiments may further include a hand guard secured around the elongate shaft at the distal end of the housing. Optionally, the hand guard may be formed by the housing or may be a separate element secured to the elongate shaft or the housing.

Some embodiments may further include an end cap secured to the distal end of the elongate shaft, wherein the end cap has a distal surface that provides a landing area for an object being held by the flexible strap. For example, as the proximal end of the flexible strap is pull in a proximal direction and the flexible strap tightens around the object, the object itself may be pulled in a proximal direction until the object is pressed against the distal end of the elongate shaft. However, an end cap with a suitable landing surface may engage the object in order to securely seat the object in a desired position. In one example, an end cap having a flat or planar landing surface that is perpendicular to the axis of the elongate shaft may, when the object is pulled firmly against the end cap, prevent the object from pivoting in a manner that changes its angle with the elongate shaft. In another example, an end cap having a landing surface with a groove that is centered about the elongate shaft may, when the object is pulled firmly against the end cap, cause the object to align with the groove and prevent the object from rotating about an axis of the elongate shaft as well as preventing the object from pivoting in a manner that changes its angle with the elongate shaft. In one option, the groove may have a V-shaped profile extending in a lateral direction. For example, the lateral direction may be substantially parallel to the first and second crossbars of the cam buckle.

Some embodiments may further include a structural member secured to a distal end of the elongate shaft and extending laterally across the first passageway through the elongate shaft. The structural member may be a fastener used to secure the end cap but may also prevent the flexible strap from becoming accidentally retracted into the elongate shaft and out of reach to a user. For example, the flexible strap may pass along a first side of the structural member as the flexible strap extends in the distal direction out the distal end of the elongate shaft, pass around a distal end of the structural member, and pass along a second side of the structural member as the flexible strap further extends in the proximal direction from the distal end of the elongate shaft. Optionally, the structural member may be substantially parallel to the first and second crossbars of the cam buckle to prevent the flexible strap from twisting.

Some embodiments of the apparatus, which may be referred to as a tool, provide the technical benefit of securely holding an object without placing a person's hand close to the object. Keeping hands away from the object may reduce the potential for injury where the object is to be positioned in a hazardous area. For example, the apparatus may hold a spike or wrench that is to be struck by a hammer.

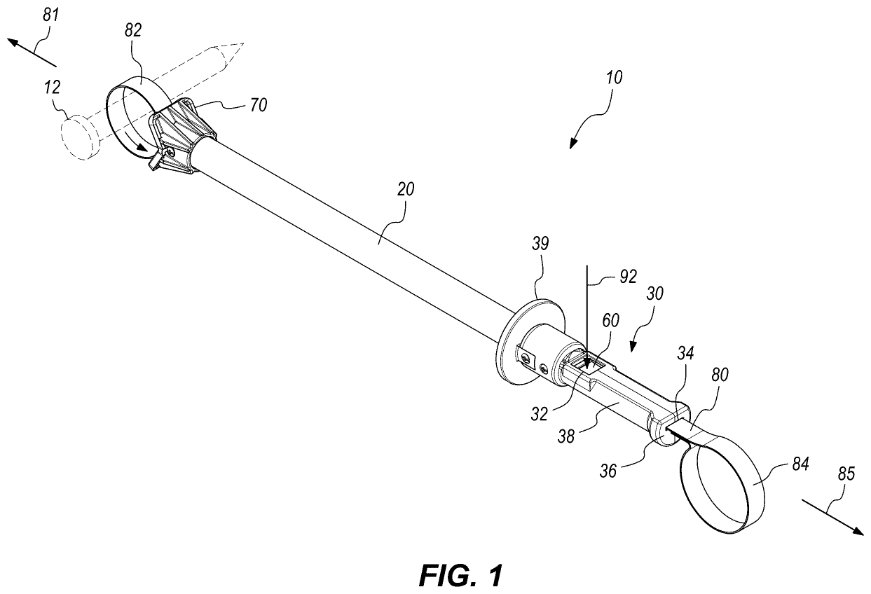

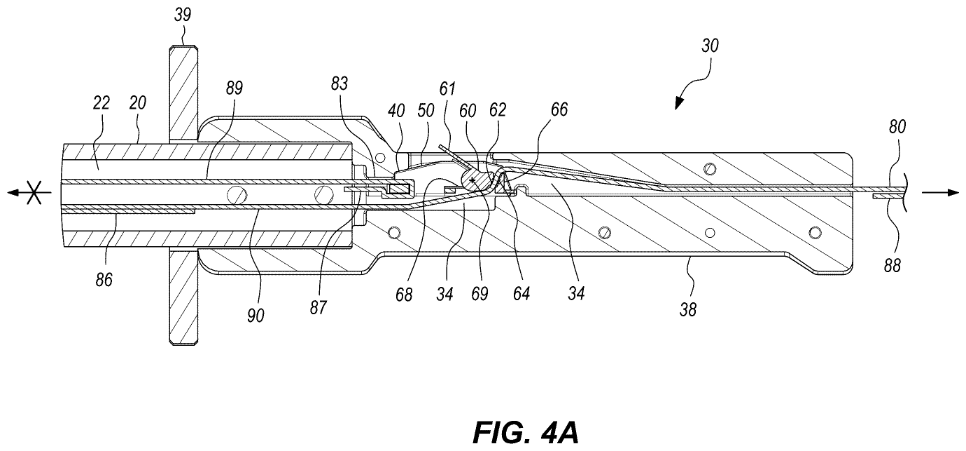

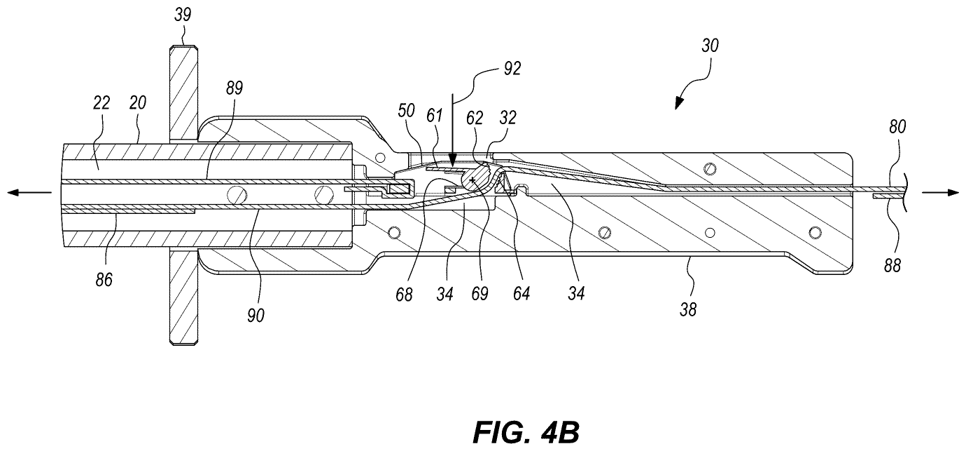

FIG. 1 is a perspective view of an apparatus or tool 10 for holding an object 12. The apparatus 10 includes an elongate shaft 20, a housing 30 secured to a proximal end of the elongate shaft 20, an end cap 70, and a flexible strap 80. The housing 30 includes a buckle chamber (not shown; see FIG. 4A) and a chamber window 32 providing access to a release button 60 (also referred to as a cam lever) of a cam buckle secured with the buckle chamber. The housing 30 further forms a handhold 38, a hand guard 39, and a passageway 34 extending from a proximal end 36 of the housing through the housing 30 and the elongate shaft 20 to form a loop 82 at a distal end of the elongate shaft 20. As shown, the end cap 70 is secured to the distal end of the elongate shaft 20 adjacent to the loop 82 that is formed by a portion of the flexible strap 80.

In operation, a person (or “user”) may open the holding loop 82 by pressing and holding down (see directional arrow 61) on the release button 60 and pulling the holding loop 82 in a distal direction (see directional arrow 81) away from the distal end of elongate shaft 20. In other words, the loop 82 may be enlarged as required for receiving the object 12 that is to be held by the tool 10. In a preferred manner of operation, a person may grasp the handhold 38 with one hand in a position to press the release button 60 with the thumb of that same hand, then pull on the loop 82 to expand the loop 82. Pulling on the loop 82 will cause a portion of the flexible strap 80 at the proximal end of the tool 10 to retract into the passageway 34 in the housing 30. Once the loop 82 has been opened to a desired size, the release button 60 may be released (i.e., no longer pressed). Once the holding loop 82 has been positioned around the object 12, the person may tighten or cinch the holding loop 82 around the object 12 by securely grasping the handhold 38 with one hand and pulling the proximal end of the flexible strap 80, such as the handle loop 84, in a proximal direction (see directional arrow 85) with the other hand. The handle loop 84 may be pulled in the proximal direction until the holding loop 82 becomes securely tightened around the object 12 and, preferably, the object is drawn into a stable position against the end cap 70. As long as the person is not pressing the release button 60, the cam buckle (not shown; see FIG. 4A) will grip the flexible strap 80 and prevent the holding loop 82 from opening. Accordingly, the object 12 is secured by the tool 10 until the person deliberately presses the release button 60. Furthermore, the person's hand(s) may be kept safely positioned on the handhold 38 and/or proximal of the hand guard 39. A subsequent operation performed on the object 12, such as another person striking the object with a hammer, will not pose a risk to the hands of the person holding the object 12. Still, the person may manipulate the tool 10 to lift, position, rotate and/or orient the object 12 as desired. When the operation is completed or the object 12 no longer needs to be held, the person may release the object by pressing and holding down on the release button 60 (also referred to as a “cam buckle trigger”; see directional arrow 61) and pulling the object 12 or holding loop 82 in a manner to open the holding loop 82 sufficiently to allow the holding loop 82 to be separated from the object 12.

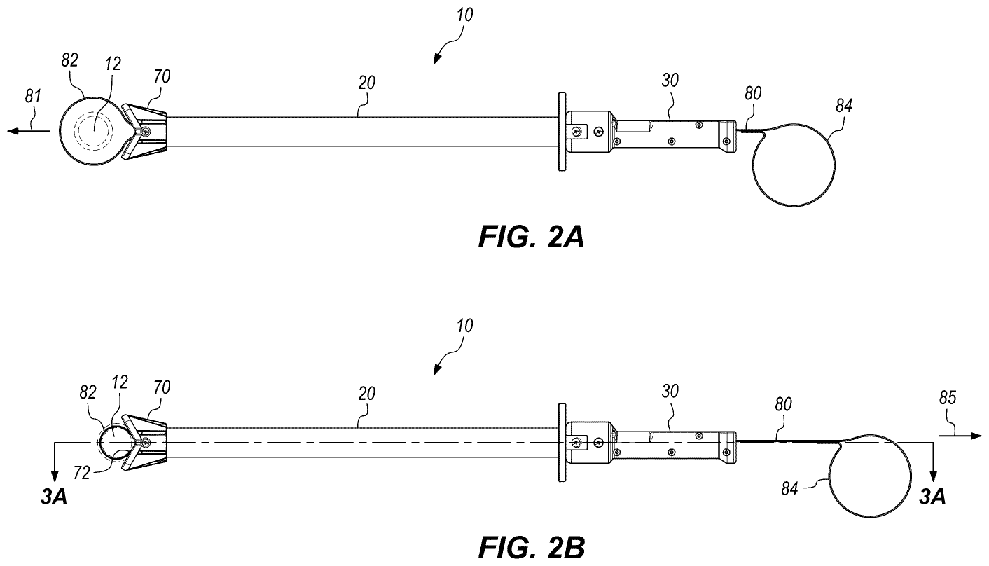

FIGS. 2A-B are side views of the tool 10 in a released condition and a holding condition, respectively. The released condition of FIG. 2A illustrates the holding loop 82 having a central opening that is able to encircle the object 12. Note that, with the release button pressed, a portion of the flexible strap 80 has been pulled in the distal direction 81 to enlarge the holding loop 82. In reference to FIG. 2B, the handle loop 84 of the flexible strap 80 has been pulled in the proximal direction 85 to contract or cinch the holding loop 82 securely around the object 12. The object 12 may be drawn in the proximal direction and/or the tool 10 may be drawn in a distal direction so that the object 12 becomes seated in a stable position with respect to the end cap 70. The end cap 70 has a V-shaped groove 72 that may cause the object 12 to be centered in the groove 72 and may reduce or prevent the object from rotating or deflecting relative to the tool 10 while being held.

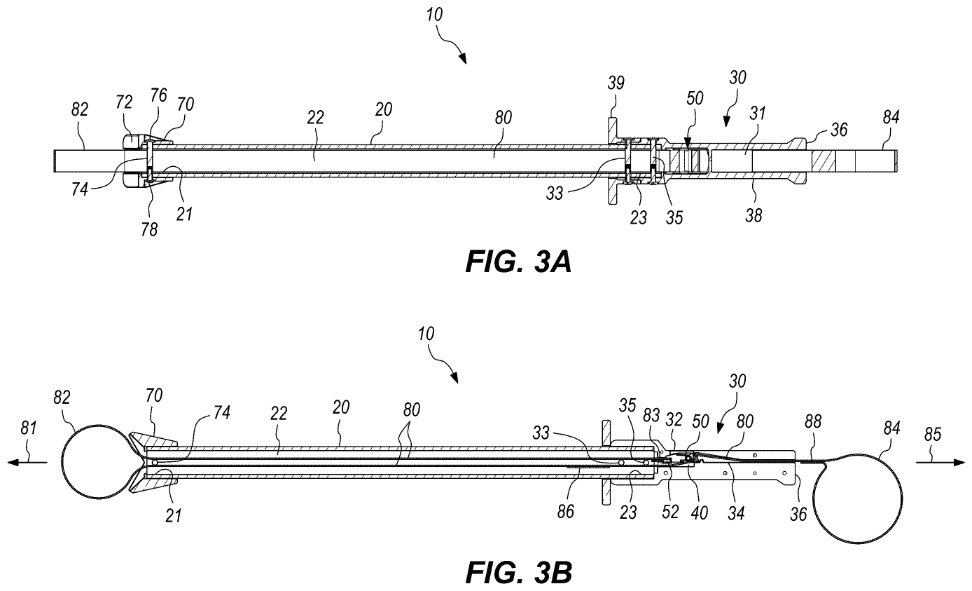

FIG. 3A is a cross-sectional view of the tool 10 taken through a horizontal plane (see line A-A in FIG. 2B). The flexible strap 80 extends through the entire tool 10 from the holding loop 82 to the handle loop 84. A first passageway 22 is formed within the elongate shaft 20 and a second passageway 31 is formed within the housing 30. The first and second passageways 22, 31 are aligned so that the flexible strap may extend within the tool 10 from the holding loop 82 to the handle loop 84. The path of the flexible strap is shown in more detail in reference to FIG. 3B.

The end cap 70 is secured to a distal end 21 of the elongate shaft 20 using a binding post assembly 74 that includes both an internally threaded binding barrel 76 and a binding screw 78 that is secured in the binding barrel 76. The heads on the binding barrel 76 and the binding screw 78 retain the end cap 70 while also extending through holes in opposing side of the elongate shaft 20. Note that the binding post assembly 74 may also form a structural member that prevents the flexible strap from accidentally retracting into the elongate shaft and out of reach to a user.

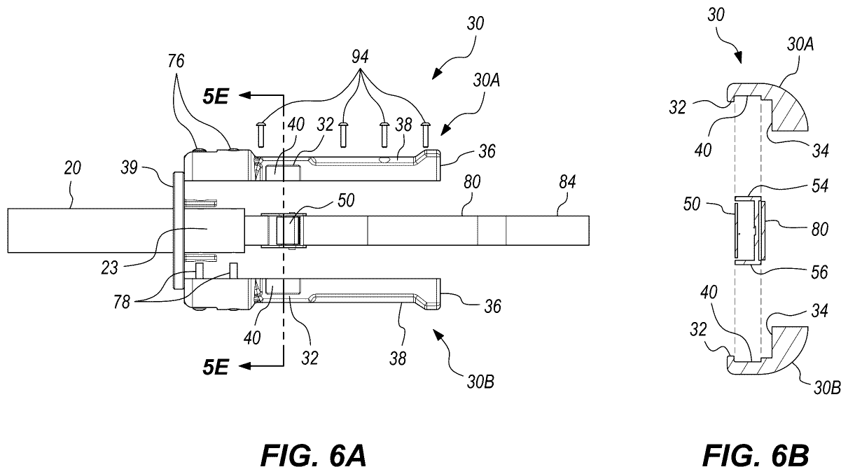

The housing 30 is secured to a proximal end 23 of the elongate shaft 20 using first and second binding post assemblies 33, 35. A cam buckle 50 is secured within the housing 30 as will be shown in greater detail in reference to FIGS. 4A, 4B, and 6A. The handhold 38 is formed by the outer contour of the housing 30 near the proximal end 36 of the housing 30 and a hand guard 39 is formed by, or secured to, a distal end of the housing 30.

FIG. 3B is a cross-sectional view of the tool 10 taken through a vertical plane (90 degrees of rotation from the horizontal plane). The tool 10 includes the elongate shaft 20 having the proximal end 23, the distal end 21, and the first passageway 22 extending through the elongate shaft 20 from the proximal end to the distal end. The housing 30 is secured to the proximal end 23 of the elongate shaft 20 and the end cap 70 is secured to the distal end 21 of the elongate shaft 20.

The housing 30 includes a buckle chamber 40, a chamber window 32, and a second passageway 34 extending from the proximal end 36 of the housing 30 through the buckle chamber 40 and into communication with the first passageway 22 in the elongate shaft 20. The tool 10 also comprises a cam buckle 50 secured in a fixed position within the buckle chamber 40. The cam buckle 40 will be described in greater detail in reference to FIGS. 4A-B.

The flexible strap 80 has a first end 83 that is secured within the elongate shaft 20 or the housing 30, such as being secured to a first crossbar 52 of the cam buckle 50. A second end of the flexible strap 80 is accessible beyond the proximal end 36 of the housing 30, wherein the second end is shown forming the handle loop 84. The flexible strap 80 extends in a distal direction 81 from the first crossbar 52 into the proximal end 23 of the elongate shaft 20 and out the distal end 21 of the elongate shaft 30, then, after forming the holding loop 82, further extends in the proximal direction 85 from the distal end 21 of the elongate shaft 20 to the proximal end 23 of the elongate shaft 20, through the second passageway 34 of the housing 30, and beyond the proximal end 36 of the housing 30.

An optional stop element 86 is secured to the flexible strap 80 to establish a limit to which the flexible strap 80 may be pulled in the proximal direction 85. Specifically, the stop element 86 may be formed by sewing a second segment of the flexible strap material face-to-face with the flexible strap 80. The stop element 86 is, alone or in combination with the flexible strap 80, too thick to enter into or pass through the second passageway 34. Similarly, the second end of the flexible strap 80 that forms the handle loop 84 may be sewn back onto itself (see point 88) to form a second stop element that will not enter into or pass through the second passageway 34.

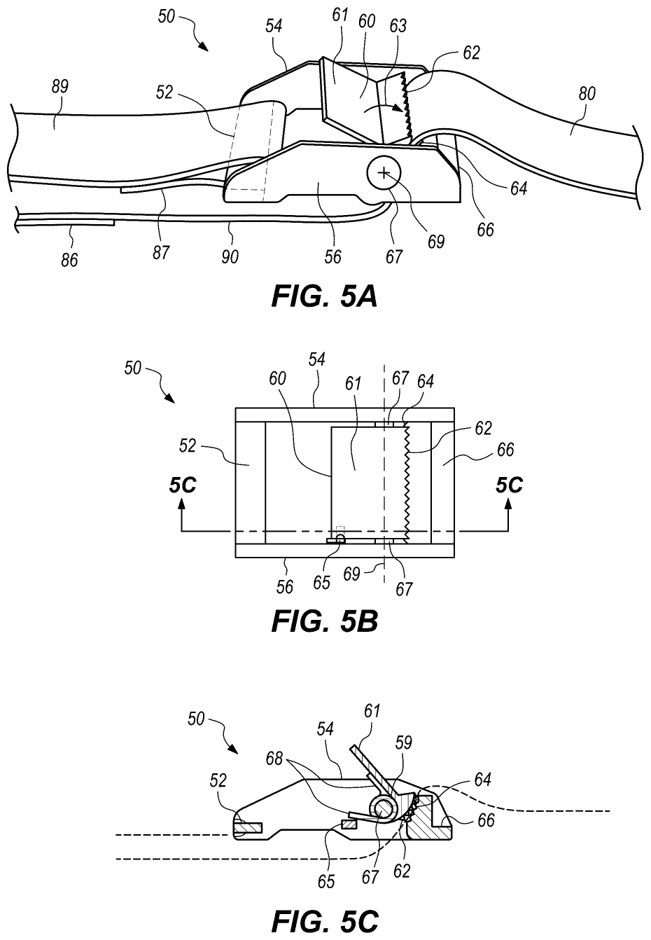

FIG. 4A is a cross-sectional side view of the releasable cam buckle 50 secured within the handle 30 of the tool 10 with the cam buckle 50 in a holding condition (i.e., gripping the flexible strap 80). The cam buckle 50 (see also FIGS. 5A-C) has a rigid frame and the buckle chamber 40 has a shape that is complementary to a shape of the cam buckle's rigid frame to prevent movement of the cam buckle 50 relative to the buckle chamber 40. Specially, the buckle chamber 40 contacts the cam buckle 50 at a sufficient number of points or surfaces to lock the cam buckle 50 in a fixed position.

The first end 83 of the flexible strap 80 is secured to the first crossbar 52 of the cam buckle 50 by looping the flexible strap material around the first crossbar 52 and sewing the flexible strap material back to itself (see point 87). The flexible strap 80 then has a first section 89 that extends in the distal direction (left in FIGS. 4A-B) through an upper portion the first passageway 22 in the elongate shaft 20 to form the holding loop (not shown) and a second section 90 that returns from the holding loop through a lower portion of the first passageway 22 extending in the proximal direction (right in FIGS. 4A-B). After the second section 90 returns from the holding loop, the flexible strap 80 further extends through the second passageway 34 in the housing 30, through the second cam buckle 50 and ultimately to the pulling loop (not shown). The second passageway 34 serves to guide the flexible strap 80 through the housing 30. The buckle chamber 40 forms part of the second passageway 34 and the cam buckle 50 is disposed in the buckle chamber 40, such that the flexible strap 80 passes through the cam buckle 50.

Specifically, the flexible strap 80 passes between a gripping surface 62 of a cam member 60 and a gripping surface 64 of another element, such as a second crossbar 66. A spring 68 biases the cam member 60 to pivot about an axis 69 and force the gripping surface 62 against the flexible strap 80, which is then gripped between the gripping surface 62 and the gripping surface 64. Given the shape of the cam member 60 and the position of the axis 69, any force on the flexible strap 80 applying tension in the distal direction (to the left in FIGS. 4A-B) will just make the cam member 60 grip the flexible strap even tighter. Accordingly, the flexible strap will resist pulling in the distal direction and will maintain a hold on the object. However, any force of the flexible strap 80 applying tension in the proximal direction (to the right in FIGS. 4A-B) may overcome the bias of the spring 68 and cause the cam member 60 to open slightly such that the flexible strap is able to slide through the cam buckle 50 with only minimal frictional resistance.

FIG. 4B is a cross-sectional side view of the releasable cam buckle 50 secured within the handle 30 of the tool 10 with the cam buckle 50 in a released condition. Relative to the holding condition of the cam buckle 50 in FIG. 4A, a person is pressing (see directional arrow 92) a cam lever 61 of the cam member 60, which is accessible through the chamber window 32. If the pressing force is sufficient to overcome the bias of the spring 68, then the cam lever 61 causes the entire cam member 60 to rotate (counter-clockwise in the view of FIGS. 4A-B) about the axis 69. This rotation of the cam member 60 about the axis 69 draws the gripping surface 62 away from the opposing gripping surface 64 and releases the grip on the flexible strap 80. Accordingly, the flexible strap 80 may be easily pulled in the distal direction (to the left in FIGS. 4A-B) to release an object from being held.

FIGS. 5A-C include a perspective view, a top view, and a cross-sectional side view of the releasable cam buckle 50. In FIG. 5A, the cam buckle 50 forms a rigid frame that includes a first side arm 54, a second side arm 56, the first crossbar 52 near a distal end, and the second crossbar 66 near a proximal end. The first and second side arms 54, 56 are connected by the first and second crossbars 52, 66

The cam member 60 includes the release button (or cam lever) 61 that is accessible through the chamber window when the cam buckle 50 is secured in the housing. The release button 61 and the gripping surface 62 are at generally opposite ends of the cam member 60. However, the cam member 60 is pivotally secured to the side arms 54, 56 by a pivot pin 67 that allows the cam member 60 to rotate about the central axis 69. The central axis 69 is generally located between the release button 61 and the gripping surface 62. A spring (not shown; see spring 68 in FIG. 5C) biases the cam member 60 about the central axis 69 in the counter-clockwise direction as shown in FIG. 5A (see the directional arrow 63). The flexible strap is disposed between the gripping surface 62 of the cam member 60 and the gripping surface 64 of the second crossbar 66.

FIG. 5B illustrates the same cam buckle 50 as in FIG. 5A, but from a top view and without the flexible strap 80.

FIG. 5C illustrates the same cam buckle 50 as in FIGS. 5A-B, but in a cross-sectional side view taken along line C-C in FIG. 5B. In this view, the coil spring 68 is shown having a first end engaging the bottom side of the release button 61 and a second end engaging a top side of a tab 65 extending from the second side arm 56 (see FIG. 5B). The coil 59 of the coil spring 68 may extend around the pivot pin 67, perhaps with the coil spring and the pivot pin having the same central axis 69.

FIGS. 6A-B are assembly views of a housing 30 that is formed by two housing halves 30A, 30B that are securable around the cam buckle 50, flexible strap 80 and the proximal end 23 of the elongate shaft 20. After positioning these components as shown in FIG. 6A, the two housing halves 30A, 30B may be pushed together carefully so that the opposing side arms of the cam buckle 50 are securely received into the opposing portions of the buckle chamber 40, the flexible strap 80 is received into the second passageway 34 in the housing 30 (see FIGS. 4A-B), and the proximal end 23 of the elongate shaft 20 is received by the distal end of the housing 30. Once the two housing halves 30A, 30B have been closed about the cam buckle, flexible strap and elongate shaft, the two housing halves 30A, 30B may be secured together with the internally threaded binding barrels 78 and binding screws 76 that extend through the elongate shaft 20 as well as some additional fasteners 94.

FIG. 6B is a partial cross-sectional view of the assembly diagram of FIG. 6A, taken along line E-E. The side arms 54, 56 of the cam buckle 50 are shown in alignment with the concave formations in the opposing sides of the buckle chamber 40, where the concave formations are sized and shaped to firmly receive the side arms and prevent movement of the cam buckle 50 relative to the housing 30. Furthermore, the second passageway 34 through the housing 30 (a portion of which is shown in FIG. 6B; see also FIGS. 3B, 4A and 4B) allows the flexible strap 80 to pass above and below portions of the cam buckle 50 as the flexible strap extends through the housing.

The terminology used herein is for the purpose of describing particular embodiments only and is not intended to limit the scope of the claims. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the embodiment.

The corresponding structures, materials, acts, and equivalents of all means or steps plus function elements in the claims below are intended to include any structure, material, or act for performing the function in combination with other claimed elements as specifically claimed. Embodiments have been presented for purposes of illustration and description, but it is not intended to be exhaustive or limited to the embodiments in the form disclosed. Many modifications and variations will be apparent to those of ordinary skill in the art after reading this disclosure. The disclosed embodiments were chosen and described as non-limiting examples to enable others of ordinary skill in the art to understand these embodiments and other embodiments involving modifications suited to a particular implementation.

What is claimed is:

1. An apparatus, comprising:
an elongate shaft having a proximal end, a distal end, and a first passageway extending through the elongate shaft from the proximal end to the distal end;
a housing secured to the proximal end of the elongate shaft, wherein the housing includes a buckle chamber, a chamber window, and a second passageway extending from a proximal end of the housing through the buckle chamber into communication with the first passageway;
a cam buckle secured in a fixed position within the buckle chamber, wherein the cam buckle includes a rigid frame and a cam member pivotably secured to the rigid frame, wherein the rigid frame includes first and second side arms connected by first and second crossbars, and wherein the cam member includes a gripping surface facing the second crossbar and a release button that is accessible through the chamber window; and
a flexible strap having a first end that is secured to a rigid member within the elongate shaft or housing and a second end that is accessible beyond the proximal end of the housing, wherein the flexible strap extends in a distal direction from the rigid member out the distal end of the elongate shaft, then further extends in a proximal direction from the distal end of the elongate shaft to the proximal end of the elongate shaft, through the second passageway of the housing, and beyond the proximal end of the housing, wherein the flexible strap is disposed between the gripping surface of the cam member and the second crossbar, and wherein the flexible strap forms a loop extending from the distal end of the elongate shaft for receiving an object within the loop, and wherein pulling the second end of the flexible strap in a proximal direction causes the loop to tighten around the object.

2. The apparatus of claim 1, wherein the cam buckle has a rigid frame and the buckle chamber has a shape that is complementary to a shape of the rigid frame to prevent movement of the rigid frame relative to the buckle chamber.

3. The apparatus of claim 2, wherein the gripping portion of the cam includes a knurled or serrated surface directed toward the second crossbar.

4. The apparatus of claim 3, wherein the second crossbar includes a knurled or serrated surface directed toward the gripping portion of the cam.

5. The apparatus of claim 1, further comprising:
an end cap secured to the distal end of the elongate shaft, wherein the end cap has a distal surface with a groove that is centered about the elongate shaft.

6. The apparatus of claim 5, wherein the groove has a V-shaped profile extending in a lateral direction, wherein the lateral direction is substantially parallel to the first and second crossbars of the cam buckle.

7. The apparatus of claim 6, wherein pulling the second end of the flexible strap in a proximal direction causes the loop to pull the object into the groove.

8. The apparatus of claim 1, further comprising:
a structural member secured to a distal end of the elongate shaft and extending laterally across the first passageway through the elongate shaft, wherein the flexible strap passes along a first side of the structural member as the flexible strap extends in the distal direction out the distal end of the elongate shaft, passes around a distal end of the structural member, and passes along a second side of the structural member as the flexible strap further extends in the proximal direction from the distal end of the elongate shaft.

9. The apparatus of claim 8, wherein the structure member is substantially parallel to the first and second crossbars of the cam buckle.

10. The apparatus of claim 1, further comprising:
a first stop element secured to the flexible strap, wherein the first stop element has a dimension that prevents the first stop element from moving through the second passageway of the housing and limits a quantity of the flexible strap that can extend beyond the proximal end of the housing.

11. The apparatus of claim 1, wherein the second end of the flexible strap forms a loop for pulling the flexible strap in the proximal direction, wherein the loop forms a second stop element having a dimension that prevents the second stop element from moving through the second passageway of the housing.

12. The apparatus of claim 1, wherein the cam buckle further includes a spring element that biases the gripping surface of the cam member toward the second crossbar, wherein a force pulling on the flexible strap in a distal direction through the cam buckle will cause the gripping surface of the cam member to be further biased against the flexible strap toward the second crossbar.

13. The apparatus of claim 12, wherein a force pulling on the flexible strap in a proximal direction though the cam buckle will cause the flexible strap to slide between the gripping surface and the second crossbar.

14. The apparatus of claim 1, further comprising:
a hand guard secured around the elongate shaft at the distal end of the housing.

15. The apparatus of claim 1, wherein the housing is formed by a first housing portion and a second housing portion that are secured together with fasteners, and wherein each housing portion is a rigid body including a portion of the buckle chamber, a portion of the chamber window, and a portion of the second passageway.

16. The apparatus of claim 1, wherein the housing is shaped to include a handhold region immediately adjacent the chamber window.

17. The apparatus of claim 16, characterized in that a person may grip the handhold region with one hand and operate the release button with a thumb of the hand without releasing the grip.

18. The apparatus of claim 1, wherein the buckle chamber has a distal end that engages a distal end of the cam buckle and prevents distal movement of the cam buckle.

19. The apparatus of claim 18, wherein the buckle chamber has a proximal end that engages a proximal end of the cam buckle and prevents proximal movement of the cam buckle.

20. The apparatus of claim 1, wherein the rigid member that secured the first end of the flexible strap is the first crossbar of the cam buckle.
